(19) United States
(12) Patent Application Publication
(10) Pub. No.: US 2005/0274207 A1
(43) Pub. Date: Dec. 15, 2005

(54) Method for controlling lift errors in semiconductor manufacturing apparatus

(76) Inventor: Seung-Man Heo, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/147,343

(22) Filed: Jun. 8, 2005

(30) Foreign Application Priority Data
Jun. 14, 2004 (KR) 2004-43417

(51) Int. Cl. G01N 19/00

(52) U.S. Cl. 73/865.9

(57) ABSTRACT

A method of detecting a lift error of a piston used to elevate a wafer in a semiconductor manufacturing apparatus is disclosed. The method provides a time limit for a piston of a cylinder used to elevate a wafer to reach a specified position, a drive command is generated to drive the piston toward the specified position, a timer is started to measure a time period from the generation of the drive command, The piston detected whether it has reached the specified position, and an alarm and interlock signal are generated if the piston has not reached the specified position before the time period has exceeded the time limit.

### BACKGROUND AND SUMMARY

1. Technical Field

The present invention generally relates to a method of manufacturing semiconductors. More particularly, the present invention relates to a method of reducing lift errors during the manufacturing of semiconductors.

A claim of priority is made to Korean Patent Application 2004-43417, filed on Jun. 14, 2004, the contents of which are hereby incorporated by reference in their entirety.

2. Description

In general, a polymide process is performed to form a protective layer on a substrate. For example, a non-photosensitive photoresist material is used as the protective layer. To form the protective layer, a substrate is coated with the photoresist, and then the substrate is heated to a predetermined temperature in a baking unit to harden the coated photoresist.

Generally a spinner is used to coat the photoresist. The spinner includes a photoresist supply line and a photoresist spraying nozzle to respectively supply and spray the photoresist onto the substrate. The spinner also includes a solvent supply line to clean and remove residual photoresist on the substrate. A solvent such as a thinner is used to perform a side rinse on an edge of the substrate and a back rinse on the backside of the substrate.

The spinner further includes a baking unit having a high-speed rotational device. Prior to a fabrication process, the baking unit sets a baking time, baking temperature, temperature offset, a lower limit alarm, and an upper limit alarm as a hot-plate/cold-plate (HP/CP) recipe as shown in FIG. 1. As shown in FIG. 2, a low pressure addition hot (LPAH) recipe can be also set. In determining the HP/CP and LPAH recipes, when a RECIPE is selected on a menu screen of a controller, one or more sub-menus, such as for a coater, or bake unit appears. “Bake” sub-menu is selected, and then the HP/CP or LPAH recipe is selected to complete the set-up.

However, one problem with a spinner apparatus, which is used to move substrates up and down during semiconductor manufacture, is that the substrates are often broken due to worn-out cylinder parts.

Accordingly, it would be desirable to provide a method of detecting a lift error in a semiconductor manufacturing apparatus.

### SUMMARY

One aspect of the present invention provides a method of detecting a lift error of a piston used to elevate a wafer in a semiconductor manufacturing apparatus by inputting to a controller a time limit for a piston of a cylinder to reach a specific position, generating by the controller a drive command for a solenoid valve to drive the piston, and starting a timer, detecting by a sensor whether the piston has reached the specific position, and sending a detection signal to the controller when the piston reaches the specific position, and generating an alarm and interlock signal by the controller if a time required for the piston to reach the specific position exceeds the time limit.

Another aspect of the present invention provides A method of detecting a lift error of a piston used to elevate a wafer in a semiconductor manufacturing apparatus by providing a time limit for a piston of a cylinder used to elevate a wafer to reach a specified position, generating a drive command to drive the piston toward the specified position, starting a timer to measure a time period from the generation of the drive command, detecting whether the piston has reached the specified position, and generating an alarm and interlock signal if the piston has not reached the specified position before the time period exceeds the time limit.

And another aspect of the present invention provides a method of detecting a lift error of a piston used to elevate a wafer in a semiconductor manufacturing apparatus by providing a time limit for a piston of a cylinder used to elevate a wafer to reach a specified position, generating a drive command to drive the piston toward the specified position, starting a timer to measure a time period from the generation of the drive command, detecting whether the piston has reached the specified position, and in response thereto generating a detection signal, and generating an alarm and interlock signal if the detection signal is not detected.

### BRIEF DESCRIPTION OF THE DRAWINGS

The present invention will be better understood from the detailed description given hereinbelow and the accompanying drawings which are given by way of illustration only, and thus do not limit the present invention, and wherein:

FIG. 1 is a screen shot of a recipe setting for HP/CP bake unit;

FIG. 2 is a screen shot of a recipe setting LPAH bake unit;

FIG. 3 illustrates a baking unit according to an exemplary embodiment of the present invention;

FIG. 4 is a flowchart to illustrate an input of up and down alarm times for a bake unit according to an exemplary embodiment of the present invention;

FIG. 5 is a flowchart of a method of controlling lift errors according to another exemplary embodiment of the present invention;

FIG. 6 illustrates screen shots used to enter a recipe before an application of an HP/CP method according to an exemplary embodiment of the present invention; and

FIG. 7 illustrates screen shot of a recipe setting after applying an LPAH according to an exemplary embodiment of the present invention.

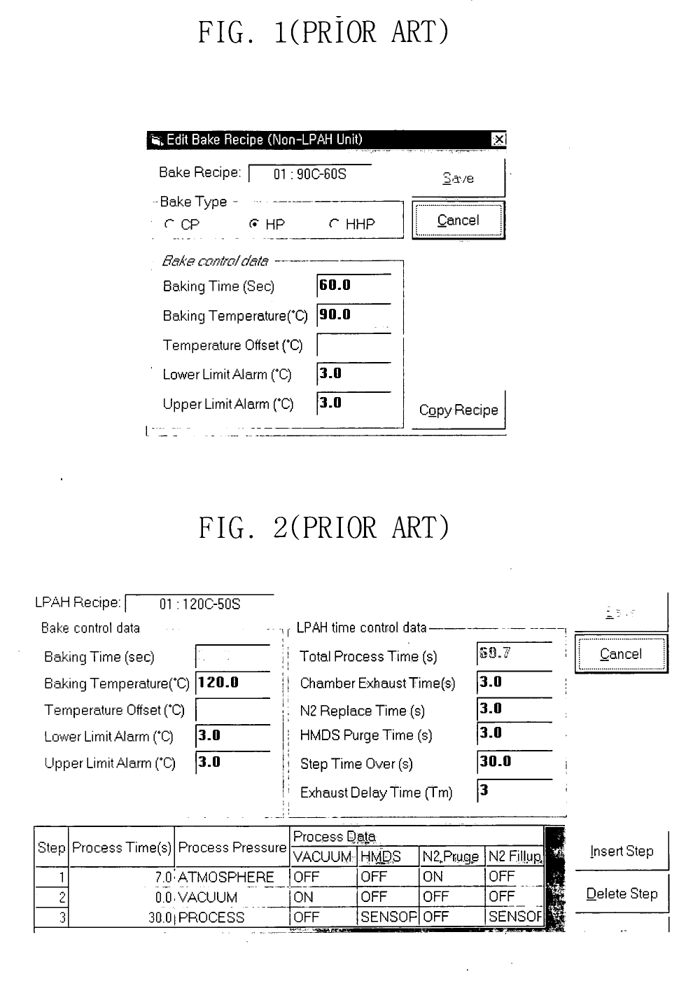

### DETAILED DESCRIPTION

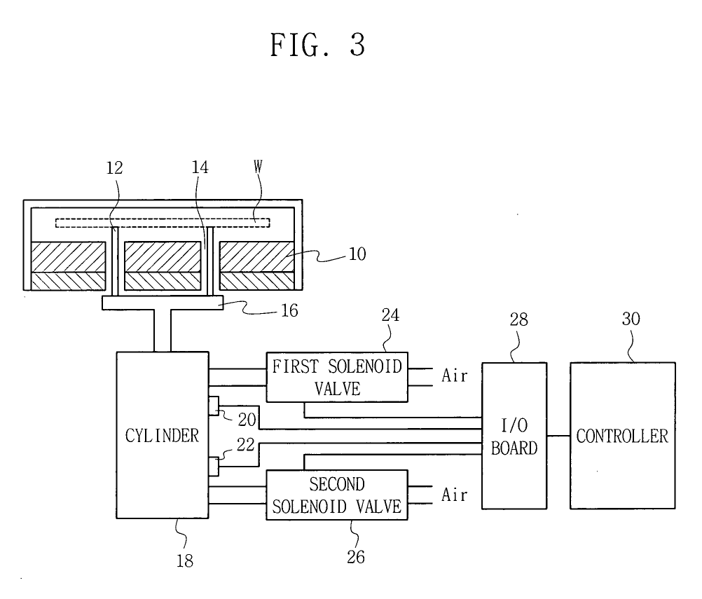

Hereinafter, exemplary embodiments of the present invention will be described in detail with reference to FIGS. 3 to 7. It will be understood by those skilled in the art that the present invention can be embodied in numerous ways and is not limited to the following described embodiments. The following various embodiments are exemplary in nature.

FIG. 3 illustrates a baking unit according to an exemplary embodiment of the present invention.

Referring to FIG. 3, the baking unit includes a bake plate 10, a lift pin holder 16, a cylinder 18, first and second sensors 20 and 22, a controller 30, first and second solenoid valves 24 and 26, and an I/O (Input/Output) board 28.

Bake plate 10 has a pin hole 14 formed therethrough. A lift pin 12 moves within pin hole 14. Lift pin 12 is connected to lift pin holder 16. A wafer W is held in place under vacuum pressure on bake plate 10.

Cylinder 18 is connected to lift pin holder 16 to drive lift pin 12 by way of a piston disposed within cylinder 18 (not shown).

First and second sensors 20 and 22 are individually installed in strategic positions on cylinder 18 to detect the position of the piston.

Controller 30 outputs a solenoid valve control signal to move the piston during a baking process. Controller 30 receives a first or second detection signal from first or second sensors 20 and 22, respectively, and in response thereto outputs a solenoid valve cut-off control signal. Controller 30 also sounds an alarm and simultaneously generates an interlock signal when the first or second detection signal is not received within a predetermined time after controller 30 generates the solenoid control signal.

First and second solenoid valves 24 and 26 move the position of lift pin holder 16 in accordance with the signal received from controller 30.

I/O board 28 interfaces the first and second detection signals, transfers them to controller 30, and respectively applies the solenoid valve cut-off control signal outputted from controller 30 to first and second solenoid valves 24 and 26.

Controller 30 is preferably a computer or any device capable of parameter input and management.

To position lift pin holder 16 to a first position, e.g., an upper position, controller 30 outputs a first solenoid valve drive signal to second solenoid valve 26. Second solenoid valve 26 opens and then supplies air to a lower portion of cylinder 18, in response to which the piston elevates lift pin holder 16. First sensor 20 detects an upper limit position of the piston when lift pin holder 16 is raised, and sends a detection signal to controller 30 through I/O board 28. Controller 30 outputs the solenoid valve cut-off control signal to second solenoid valve 26 through I/O board 28, and then second solenoid valve 26 closes and shuts off the air to cylinder 18.

To move lift pin holder 16 to a second position, e.g., a lower position, controller 30 outputs a second solenoid valve drive signal to first solenoid valve 24. Then, first solenoid valve 24 opens and supplies air to an upper portion of cylinder 18. When the air is supplied, the piston moves lift pin holder 16 down. Second sensor 22 detects a lower limit position of the piston and sends the detection signal to controller 30 via the I/O board 28. Controller 30 outputs a solenoid valve cut-off control signal to first solenoid valve 24, and in response thereto, first solenoid valve 24 closes and shuts off the air to cylinder 18. The lowest position of the piston governs the lowest position of lift pin holder 16, while the highest position of the piston governs the highest position of lift pin holder 16.

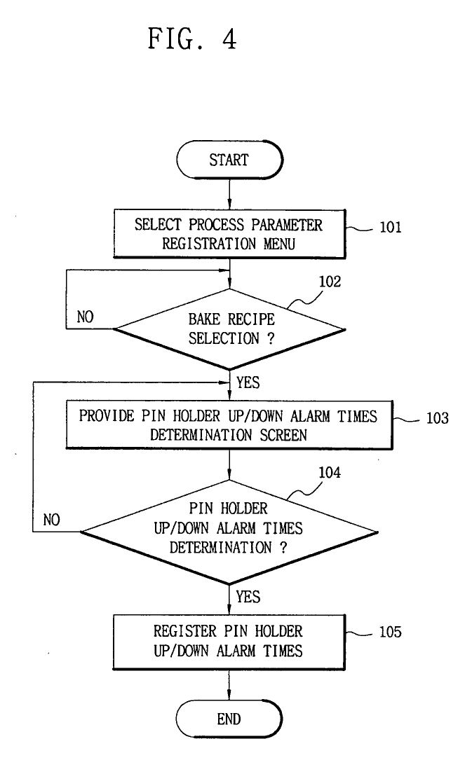

Referring to FIGS. 4 to 7, operations of a method of controlling lift error in a semiconductor manufacturing apparatus will be disclosed.

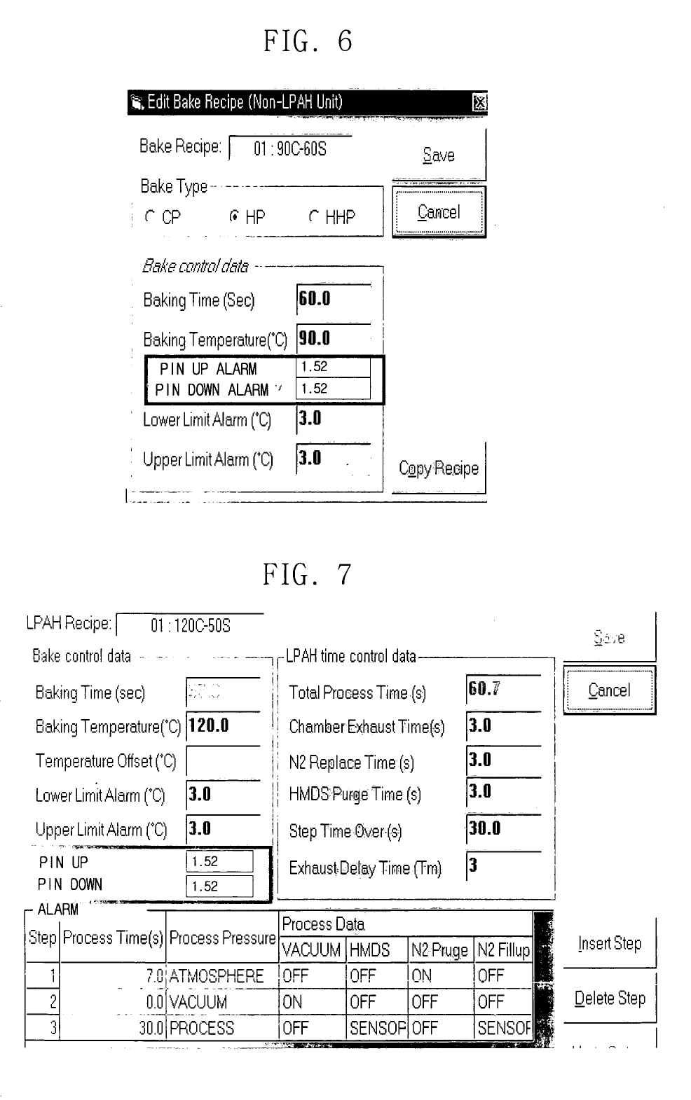

Referring first to FIG. 4, in determining lift pin holder upper and lower position alarm times for a baking unit, an operator selects a process parameter registration menu through a controller 30 (S101). Controller 30 checks whether a bake recipe has been selected (S102). If the bake recipe has been selected (S102), controller 30 provides a screen menu similar to the ones depicted in FIGS. 6 or 7 to determine the lift pin holder up alarm time, and the lift pin holder down alarm time (S103). Then, the operator inputs the lift pin holder up/down alarm times (S104), for example, about 1.5 seconds each. Then controller 30 registers the pin holder up/down alarm times to a database (S105).

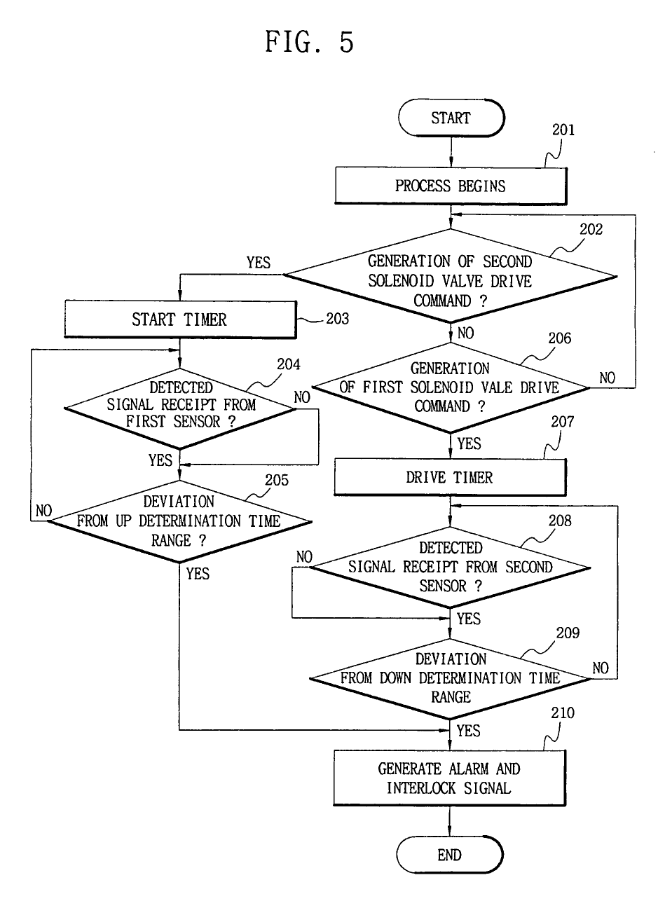

An operation of detecting and controlling a lift error generated during in a process after inputting, i.e., registering, the pin holder up/down alarm times will be described with reference to FIG. 5.

A baking process commences after an operator inputs a baking process command through a controller 30. Controller 30 begins the baking process (S201). Then, controller 30 checks whether a drive command for a second solenoid valve 26 has been generated (S202). If yes, controller 30 starts an internal timer (S203). The second solenoid valve drive command is applied to second solenoid valve 26 through an I/O board 28. Second solenoid valve 26 opens to supply air to a piston of a cylinder 18. When the piston moves to a predetermined position, a first sensor 20 detects an upper limit position of the piston and sends a detection signal to controller 30 checks whether the detection signal has been received from first sensor 20 (S204) and the process moves to step 205 regardless of the signal receipt from the sensor. In step 205, controller 30 checks whether the timer has exceeded a pin holder up alarm determination time range. In other words, whether the time required to reach the first position has exceeded the allowed about 1.5 seconds. If the time has not been exceeded, the process returns to step 204, but if time has been exceeded, the process moves to step 210. In step 210, controller 30 sounds an alarm to inform the operator that a lift error has occurred and also generates an interlock signal.

If a second solenoid valve drive command is not generated in step 202, the process moves to step 206 and controller 30 checks whether a drive command of a first solenoid valve has been generated, and if it has been generated, the process moves to step 207. In step 207, controller 30 starts an internal timer. The first solenoid valve drive command is applied to a first solenoid valve 24 through I/O board 28. First solenoid valve 24 opens to supply air to the piston. When the piston moves to a predetermined position, a second sensor 22 detects a lower limit position of the piston and applies a detection signal to controller 30. Controller 30 checks whether the detection signal was received from second sensor 22 (S208), and the process moves to step 209 regardless of the signal receipt from the sensor. Controller checks whether the timer has exceeded a pin holder down alarm determination time range. In other words, controller 30 checks whether the time required to reach the second position has exceeded the allowed 1.5 seconds. If the time has not been exceeded, the process returns to step 208, but if the time has been exceeded, the process moves to step 210. In step 210, controller 30 sounds an alarm to inform the operator that a lift error has occurred and also generates an interlock signal.

As explained above, the pin holder up/down alarm times may be for example about 1.5 seconds. Once second solenoid valve 26 is driven, after about 1.2˜1.3 seconds a detection signal should be received by controller 30. If controller 30 does not receive the detection signal by the allotted time, then controller 30 generates an alarm and interlock signal. Once first solenoid valve 24 is driven, after about 1.2˜1.3 seconds a detection signal should be received by controller 30. If controller 30 does not receive the detection signal by the allotted time, then controller 30 generates an alarm and interlock signal.

It will be apparent to those skilled in the art that modifications and variations can be made to the present invention without deviating from the scope of the present invention. Thus, it is intended that the present invention cover any such modifications and variations of the present invention.

1. A method of detecting a lift error of a piston used to elevate a wafer in a semiconductor manufacturing apparatus, the method comprising:
inputting to a controller a time limit for a piston of a cylinder to reach a specific position;
generating by the controller a drive command for a solenoid valve to drive the piston, and starting a timer;
detecting by a sensor whether the piston has reached the specific position, and sending a detection signal to the controller when the piston reaches the specific position; and
generating an alarm and interlock signal by the controller if a time required for the piston to reach the specific position exceeds the time limit.

2. The method of claim 1, wherein the specific position is an upper position.

3. The method of claim 1, wherein specific position is a lower position.

4. The method of claim 1, wherein the piston is driven by air supplied to the solenoid valve.

5. A method of detecting a lift error of a piston used to elevate a wafer in a semiconductor manufacturing apparatus, the method comprising:
providing a time limit for a piston of a cylinder used to elevate a wafer to reach a specified position;
generating a drive command to drive the piston toward the specified position;
starting a timer to measure a time period from the generation of the drive command;
detecting whether the piston has reached the specified position; and
generating an alarm and interlock signal if the piston has not reached the specified position before the time period exceeds the time limit.

6. The method of claim 5, wherein the specified position is an upper position.

7. The method of claim 5, wherein specified position is a lower position.

8. The method of claim 5, wherein the piston is driven by air supplied to a solenoid valve connected to the cylinder.

9. The method of claim 5, wherein the drive command and timer are controlled by a controller connected to the cylinder.

10. The method of claim 5, wherein the specified position is detected by a sensor attached to the cylinder.

11. A method of detecting a lift error of a piston used to elevate a wafer in a semiconductor manufacturing apparatus, the method comprising:
providing a time limit for a piston of a cylinder used to elevate a wafer to reach a specified position;
generating a drive command to drive the piston toward the specified position;
starting a timer to measure a time period from the generation of the drive command;
detecting whether the piston has reached the specified position, and in response thereto generating a detection signal; and
generating an alarm and interlock signal if the detection signal is not detected.

12. The method of claim 11, wherein the specified position is an upper position.

13. The method of claim 12, wherein specified position is a lower position.

14. The method of claim 11, wherein the piston is driven by air supplied to a solenoid valve connected to the cylinder.

15. The method of claim 11, wherein the drive command and timer are controlled by a controller connected to the cylinder.

16. The method of claim 5, wherein the specified position is detected by a sensor attached to the cylinder.
